(19) United States
(12) Patent Application Publication
(10) Pub. No.: US 2007/0009140 A1
(43) Pub. Date: Jan. 11, 2007

(54) Code generating device using biometric information

(76) Inventors: Kouji Jitsui, Fukuoka (JP); Katsunari Togasaki, Fukuoka (JP); Kazuya Jinbo, Kawasaki (JP); Yoshimasa Sekiya, Kawasaki (JP); Masayoshi Kamada, Fukuoka (JP); Harutaka Tanaka, Fukuoka (JP); Hiroaki Kiyota, Fukuoka (JP); Tomokazu Makino, Fukuoka (JP); Norihito Nishimoto, Fukuoka (JP); Mitsuhiro Sato, Fukuoka (JP); Satoshi Kanekiyo, Fukuoka (JP)

Correspondence Address: BINGHAM MCCUTCHEN LLP, 3000 K STREET, NW, BOX IP, WASHINGTON, DC, 20007, US

(21) Appl. No.: 11/268,655

(22) Filed: Nov. 8, 2005

(30) Foreign Application Priority Data
Jul. 5, 2005 (JP) JP2005-196532

(51) Int. Cl. G06K 9/00

(52) U.S. Cl. 382/115

(57) ABSTRACT

A code generating device using biometric information, includes an input unit of biometric information, a storage unit stored with a plurality of biometric information patterns and with codes each uniquely assigned to each biometric information pattern, a code generating unit extracting one of the plurality of biometric information patterns, which corresponds to the inputted biometric information, and acquiring the code assigned to the extracted biometric information pattern, and an output unit outputting the code acquired by the code generating unit.

### BACKGROUND OF THE INVENTION

1. Field of the Invention

The invention relates to a device generating a code by use of biometric information and a method thereof.

2. Description of the Related Art

In a conventional authentication system, individual authentication employing an authentication code such as a secret identification code and a password is conducted. In the majority of cases, a user sets an authentication code by using individual information (e.g., a date of birth and a telephone number) related to the user. In this case, a problem arises, wherein other persons analogy the authentication code from the individual information, thus performing unlawful individual authentication.

In view of this problem, what is considered is to set the authentication code making other persons unable to easily analogy. In this case, however, the user himself or herself might forget the authentication code. Further, the other persons might know the authentication code from a memorandum etc. created to avoid user's forgetting.

Over the recent years, an authentication system employing biometric information launches into being provided. The biometric information is unreplaceable information. Hence, a problem arises in terms of safeguarding the privacy.

Also, there is a problem that the user might feel reluctant or repellent against registering the individual physical information in the system. Further, a basic (backbone) system for the individual authentication is required to be restructured, resulting in a problem that a tremendous cost occurs.

A document of the prior art related to the invention is disclosed in the following document.

[Patent document 1] WO Publication No. 01/042938

### SUMMARY OF THE INVENTION

It is an object of the present invention to provide a technology capable of improving usability and reliability by eliminating a user's action of memorizing or recording the authentication code and of registering the biometric information in an operation system of an authentication system.

The present invention adopts the following means in order to solve the problem given above.

Namely, the present invention is a code generating device using biometric information, comprising:

an input unit of biometric information;

a storage unit stored with a plurality of biometric information patterns and with codes each uniquely assigned to each biometric information pattern;

a code generating unit extracting one of the plurality of biometric information patterns, which corresponds to the inputted biometric information, and acquiring the code assigned to the extracted biometric information pattern; and

an output unit outputting the code acquired by the code generating unit.

Preferably, the code generating device according to the present invention further comprises:

an input unit of a code format; and

a code processing unit processing the code acquired by the code generating unit in accordance with the inputted code format,

wherein the output unit outputs the processed code.

Further, preferably, the code generating device according to the present invention further comprises:

an input unit of a processing pattern of the code; and

a code processing unit processing the code acquired by the code generating unit in accordance with the inputted processing pattern,

wherein the output unit outputs the processed code.

Moreover, preferably, in the code generating device according to the present invention, the code generating unit, when plural pieces of biometric information are inputted from the biometric information input unit, extracts the biometric information patterns corresponding to respective pieces of biometric information, acquires a plurality of codes matching with the respective biometric information patterns extracted, and generates a new code from the plurality of codes.

Still further, according to the present invention, in a code generating device including an input unit, a storage unit stored with a plurality of biometric information patterns and with codes each uniquely assigned to each biometric information pattern, a code generating unit, and an output unit, a code generating method using biometric information comprises:

the code generating unit extracting one of the plurality of biometric information patterns, which corresponds to the biometric information inputted from the input unit, by referring to the storage unit, and acquiring the code assigned to the extracted biometric information pattern; and

the output unit outputting the acquired code.

According to the invention, it is possible to provide the technology capable of improving the usability and the reliability by eliminating the user's action of memorizing or recording the authentication code and of registering the biometric information in the operation system of the authentication system.

### BRIEF DESCRIPTION OF THE DRAWINGS

FIG. 1 is a diagram showing an example of a configuration in a first embodiment of a code generating device;

FIG. 2 is a sequence diagram showing an operational example of the first embodiment;

FIG. 3 is a diagram showing an example of a configuration in a second embodiment of the code generating device;

FIG. 4 is a sequence diagram showing an operational example of the second embodiment;

FIG. 5 is a diagram showing an example of a configuration in a third embodiment of the code generating device;

FIG. 6 is a sequence diagram showing an operational example of the third embodiment;

FIG. 7 is a diagram showing an example of a configuration in a fourth embodiment of the code generating device;

FIG. 8 is a sequence diagram showing an operational example of the fourth embodiment;

FIG. 9 is a diagram showing an example (specific example 1) of configurations of an input unit and an output unit that can be applied to the first through fourth embodiments;

FIG. 10 is a diagram showing an example of a biometric information template;

FIG. 11A is a diagram showing a specific example of a code format input unit;

FIG. 11B is a diagram showing a specific example of the code format input unit;

FIG. 12 is an explanatory diagram of a specific example of code processing based on the code format by a code processing unit;

FIG. 13A is a diagram showing a specific example of a processing pattern input unit;

FIG. 13B is a diagram showing a specific example of the processing pattern input unit;

FIG. 14 is an explanatory diagram of a specific example of the code processing based on the code pattern and the code format by the code processing unit; and

FIG. 15 is an explanatory diagram of an example of generating the code by inputting plural pieces of biometric information.

### DESCRIPRION OF THE PREFERRED EMBODIMENTS

Embodiments of the present invention will hereinafter be described with reference to the drawings. Configurations of the embodiments are exemplifications, and the present invention is not limited to the configurations of the embodiments.

### First Embodiment

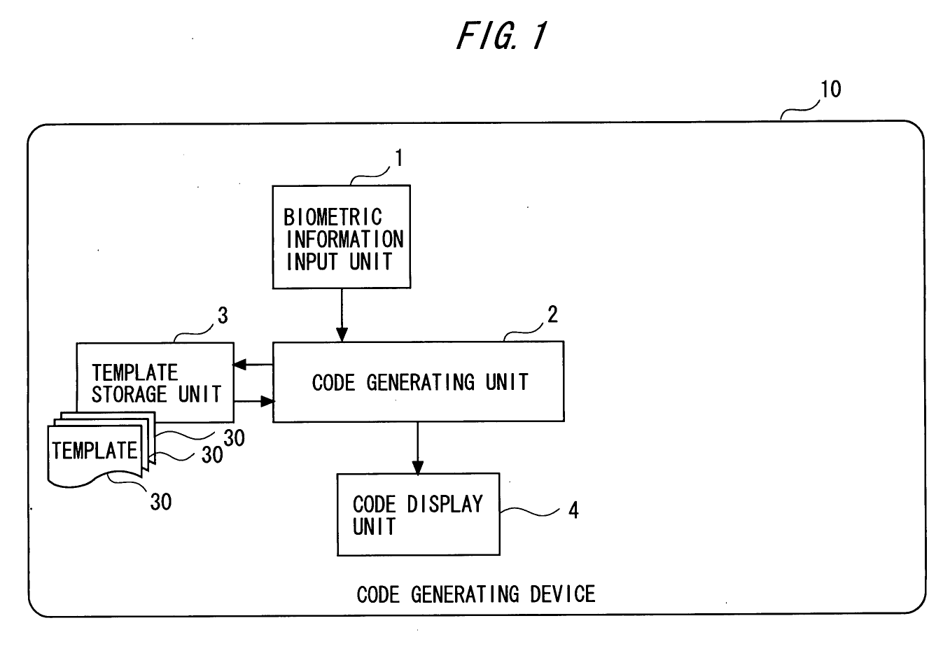

FIG. 1 is a diagram showing an example of a configuration of a first embodiment (a code generating device 10) of a code generating device according to the present invention.

<<Example of Configuration of First Embodiment>>

In FIG. 1, the code generating device 10 includes a biometric information input unit 1 for inputting biometric information of a user, a code generating unit 2 that generates a code by use of the biometric information, a template storage unit 3 to which the code generating unit 2 for generating the code refers, and a code display unit 4 (corresponding to an output unit) that displays the code generated by the code generating unit 2.

The biometric information input unit 1 includes a sensor for acquiring the user's biometric information. As the biometric information, at least one category of, e.g., a fingerprint, an iris, a retina and a blood vessel (veins) can be applied.

In the case of applying the fingerprint as the biometric information, a variety of reading methods such as a pattern matching method (image matching method), a minutia method (minutia (featuring point) extraction collation method), a minutia relation method, a chip (minute image) matching method and a frequency analyzing method, can be applied as methods of detecting (reading) fingerprint information that should be compared with a biometric information pattern (sample).

The code generating unit 2 extracts one of a plurality of biometric information samples corresponding to the biometric information inputted by the biometric information input unit 1. The code generating unit 2 refers to the template storage unit 3 in order to extract the biometric information samples.

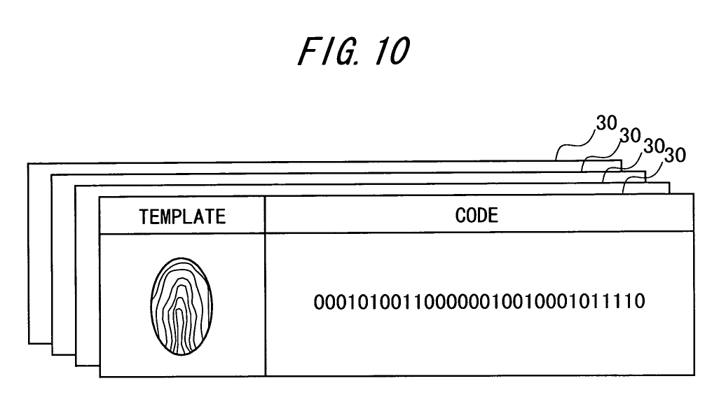

A plurality of biometric information templates 30 is stored in the template storage unit 3. Each of the biometric information templates 30 contains biometric information patterns (samples) and codes each uniquely assigned to the biometric information pattern (see FIG. 10).

The biometric information can be classified into a plurality of types. The biometric information pattern is one of the patterns corresponding to any one of the plural types of biometric information. The plurality of biometric information patterns are different from each other, and the biometric information to be inputted can be applied to any one of the plural biometric information patterns.

The sample as the biometric information pattern may be a sample obtained from a person serving as a monitor and may also be an artificially created sample. The code is a character string having an arbitrary number of digits, which consists of at least one category among numerals, alphabetical characters (alphabets) symbols and other characters.

The code generating unit 2, when receiving the biometric information from the biometric information input unit 1, refers to each of the biometric information templates 30 within the template storage unit 3, and compares the biometric information with the respective biometric information patterns. Based on results of the comparisons, the code generating unit 2 can extract, for example, the biometric information pattern exhibiting the highest similarity to the bio metric information as a pattern corresponding to the biometric information.

In the present invention, however, it may be sufficient that one pattern can be extracted from the plurality of patterns. Therefore, the code generating unit 2 may extract the biometric information pattern exhibiting the lowest similarity to the biometric information. Alternatively, the code generating unit 2 may also extract the biometric information pattern that is the n-th (n is a natural number) highest pattern in its similarity to the biometric information.

The code generating unit 2, upon extracting the biometric information pattern, acquires (reads) the code assigned to this pattern. Thereafter, the code generating unit 2 inputs the acquired code to the code display unit 4.

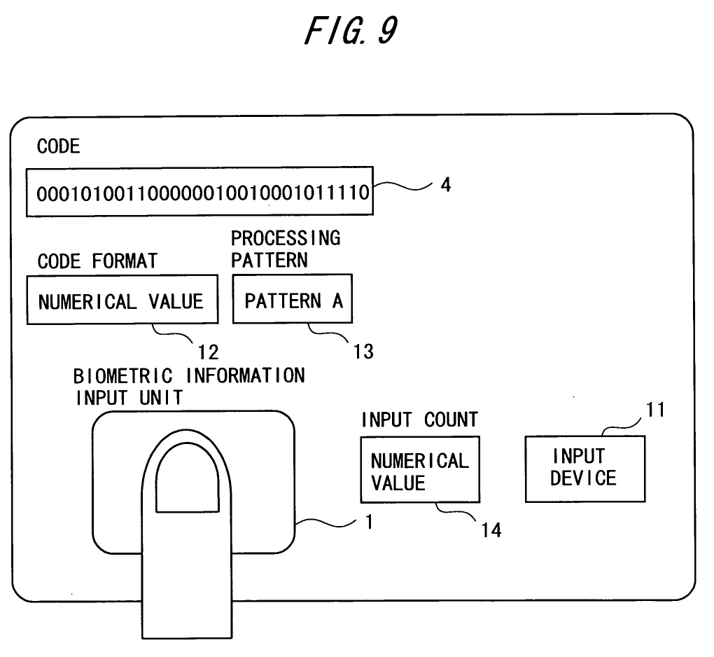

The code display unit 4 is constructed of a display device having a display screen (see FIG. 9) for displaying the code, a display control device thereof, and soon. The display control device of the code display unit 4 displays the code received from the code generating unit 2 on the display screen of the display device.

In the configuration described above, the code generating unit 2 is constructed of a processor such as a CPU (Central Processing Unit), a storage device (memory) stored with a program executed by this processor and with data used when executing the program, an input/output interface, etc., and can be actualized as a function acquired by the processor's executing the program. Further, the template storage unit 3 is created on the storage device (memory: storage unit) employed by the code generating unit 2.

<<Operational Example in First Embodiment>>

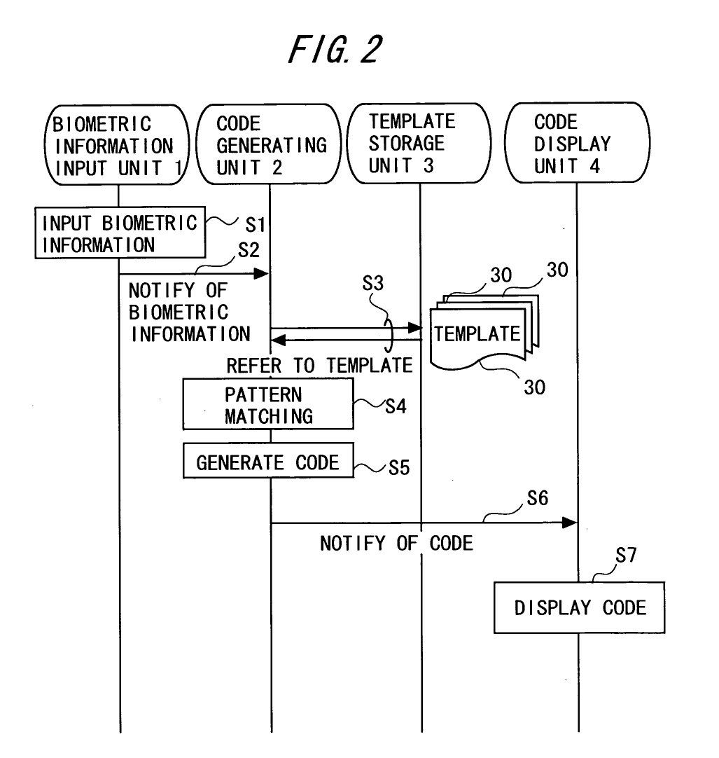

FIG. 2 is a sequence diagram showing an operational example in the code generating device 10 (the first embodiment). In FIG. 2, the user desiring to obtain the code based on the biometric information, at first, inputs the biometric information by use of the biometric information input unit 1 (step S1). The code generating unit 2 is notified of the inputted biometric information (step S2)

The code generating unit 2, when receiving the biometric information, refers to (reads) the plurality of biometric information templates 30 stored on the template storage unit 3 (step S3), and collates (e.g., pattern matching) the biometric information with the biometric information patterns stored on the respective biometric information templates 30 (step S4).

At this time, the code generating unit 2 extracts, e.g., the biometric information pattern exhibiting the highest similarity to the biometric information, and acquires the code assigned to this biometric information pattern (step S5). The code generating unit 2 notifies the code display unit 4 of the acquired code (step S6).

The code display unit 4 displays the notified code (step S7). The user can recognize the desired code by referring to the code displayed on the code display unit 4.

<<Effect of First Embodiment>>

According to the first embodiment, when the user inputs the biometric information to the code generating device 10, the code corresponding to the biometric information is displayed on the code display unit 4. Through this operation, the user is able to obtain the desired code. The code obtained by the user can be utilized as an authentication code in an authentication system. To be specific, the user, after registering, as the authentication code, the code obtained from the code generating device 10, can make individual authentication by employing this authentication code.

According to the first embodiment, the user can acquire the authentication code having nothing related to user's own individual information by use of the code generating device 10. When registering this type of authentication code in the authentication system, none of other persons can analogize the authentication code from the user's own individual information.

Further, even if the user forgets the authentication code, the same code as the authentication code already registered in the authentication system or a new authentication code can be acquired by use of the code generating device 10. Therefore, the user has no necessity of memorizing the authentication code and recording the authentication code on a recording medium such as a memorandum or a notebook. The configuration given above enables usability of the user to be improved.

Moreover, in the first embodiment, the user's biometric information is temporarily used for inferring the code corresponding to the biometric information within the code generating device 10 but becomes unnecessary after the code has been acquired. Hence, the code generating device 10, after finishing the process in step S5, deletes the biometric information.

With this contrivance, the user's biometric information can be prevented from being stolen by other persons. Namely, high security for the biometric information can be ensured. Accordingly, reliability from the users can be enhanced. Further, the biometric information is not registered within the code generating device 10, and hence the user has no sense of reluctance or repellence against registering the user's biometric information.

Moreover, according to the first embodiment, the uniqueness of the code is raised, whereby individuality as unique as the biometric information can be ensured. Owing to this uniqueness, the security as high as a biometric information authentication level can be actualized.

### Second Embodiment

Next, a second embodiment (a code generating device 10A) of the code generating device according to the present invention, will be explained. The second embodiment includes common points to the first embodiment, and therefore the discussion will be focused on different points.

<<Example of Configuration of Second Embodiment>>

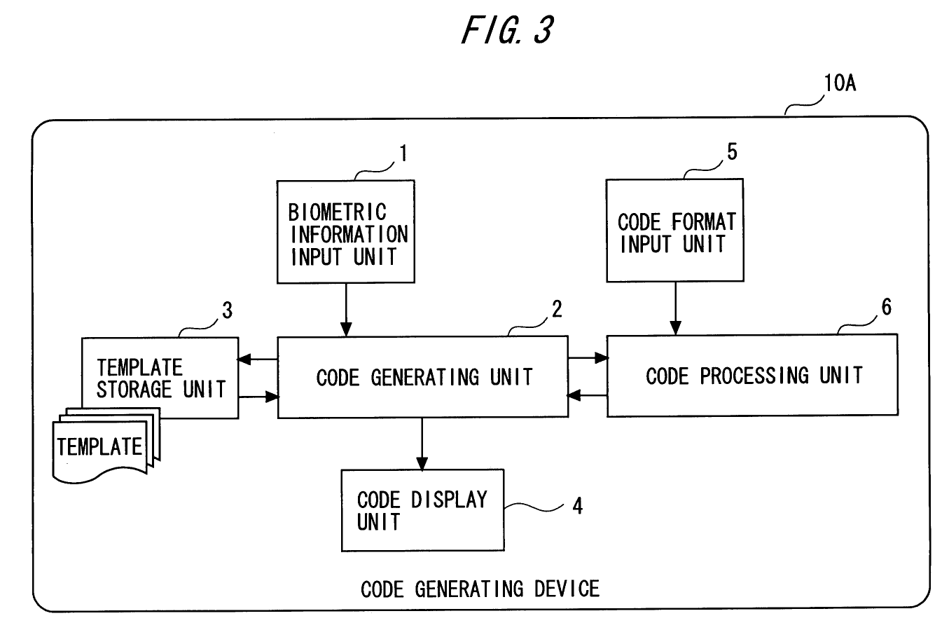

FIG. 3 is a diagram showing an example of a configuration of the second embodiment (the code generating device 10A). The code generating device 10A shown in FIG. 3 has additions of a code format input unit 5 and a code processing unit 6 to the code generating device 10 shown in FIG. 1.

The code format input unit 5 is provided for inputting information used for the user to designate a code format of the code displayed on the code display unit 4. The code format contains a type of the character, the number of digits, etc. forming the code. The code format input unit 5 includes, for instance, an input device (e.g., a keyboard, buttons) used for the user to input the code format and a display device on which input contents are displayed. At this time, the code format input unit 5 may also be configured so that options of the code format are displayed on the display device, and the user designates a desired option by the input device (e.g., a pointing device).

The code processing unit 6 processes the code acquired by the code generating unit 2 from the template storage unit 3 in accordance with the code format inputted from the code format input unit 5. For example, the code processing unit 6 changes the type of the character in the code and changes the number of digits of the code in accordance with the inputted code format. The code processing unit 6, upon finishing the processing of the code, transfers the processed code to the code generating unit 2.

The code processing unit 6 is constructed of a processor such as a CPU, a storage device (memory) stored with a program executed by this processor and with data used when executing the program, an input/output interface, etc., and can be actualized as a function acquired by the processor's executing the program.

<<Operational Example of Second Embodiment>>

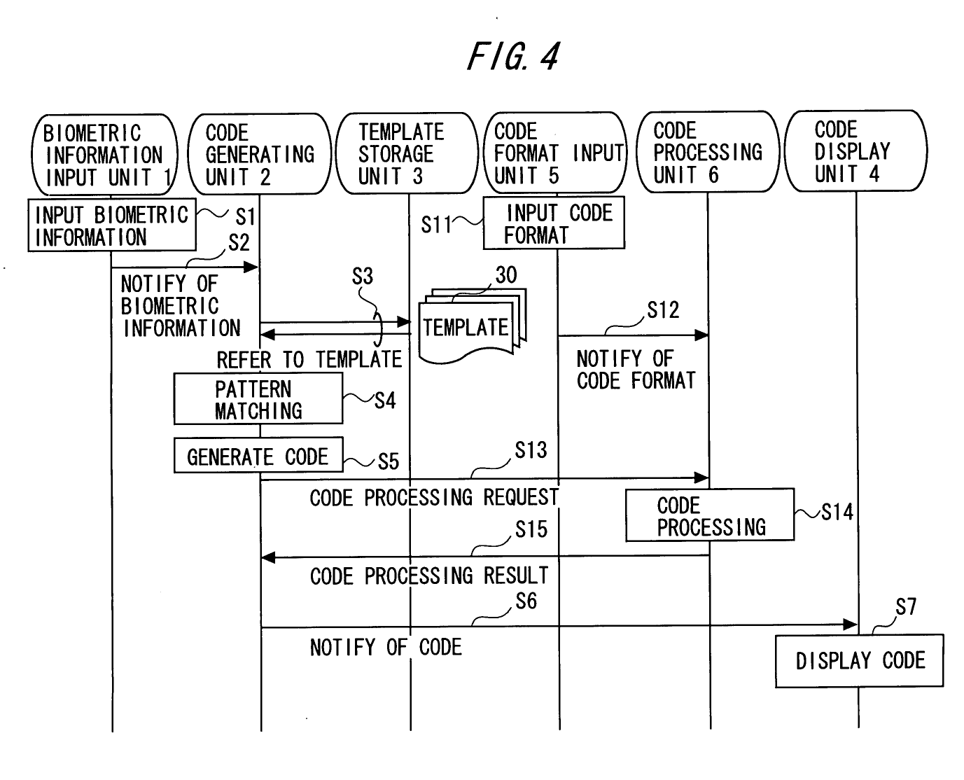

FIG. 4 is a sequence diagram showing an operational example of the code generating device 10A (the second embodiment). The operational example shown in FIG. 4 is in such a state that steps S11 through S15 are inserted in between step S5 and step S7 in the operational example shown in FIG. 2. Therefore, the explanation will be focused on steps S11 through S15.

In step S11, the user inputs (designates) the code format by use of the code format input unit 5. The code format input unit 5 notifies the code processing unit 6 of the inputted code format (step S12). The code processing unit 6 retains the notified code format.

In step S5, the code generating unit 2, when obtaining the code matching with the biometric information, notifies the code processing unit 6 of this code and requests the code processing unit 6 to process the code (step S13).

The code processing unit 6, when receiving the code from the code generating unit 2, processes the code in accordance with the code format obtained in step S12 (step S14). After finishing the processing of the code, the code processing unit 6 notifies the code generating unit 2 of the processed code as a result of processing the code (step S15).

The code generating unit 2, upon receiving the processed code, notifies the code display unit 4 of this processed code (step S6). The code display unit 4 displays the processed code. Through this operation, the user can acquire the code having the code format designated by the user himself or herself in a way that refers to the processed code displayed.

<<Effect of Second Embodiment>>

According to the second embodiment, in addition to the effect explained in the first embodiment, the following effect can be obtained. Specifically, the user is able to obtain the code in the self-desired code format. Namely, it is possible to acquire the code that should be registered in the authentication system with the number of digits and the type of the character corresponding to the authentication system employed by the user. Hence, the usability of the user can be further enhanced.

### Third Embodiment

Next, a third embodiment (a code generating device 10B) of the code generating device according to the present invention, will be explained. The third embodiment includes common points to the first and second embodiments, and therefore the discussion will be focused on different points.

<<Example of Configuration of Third Embodiment>>

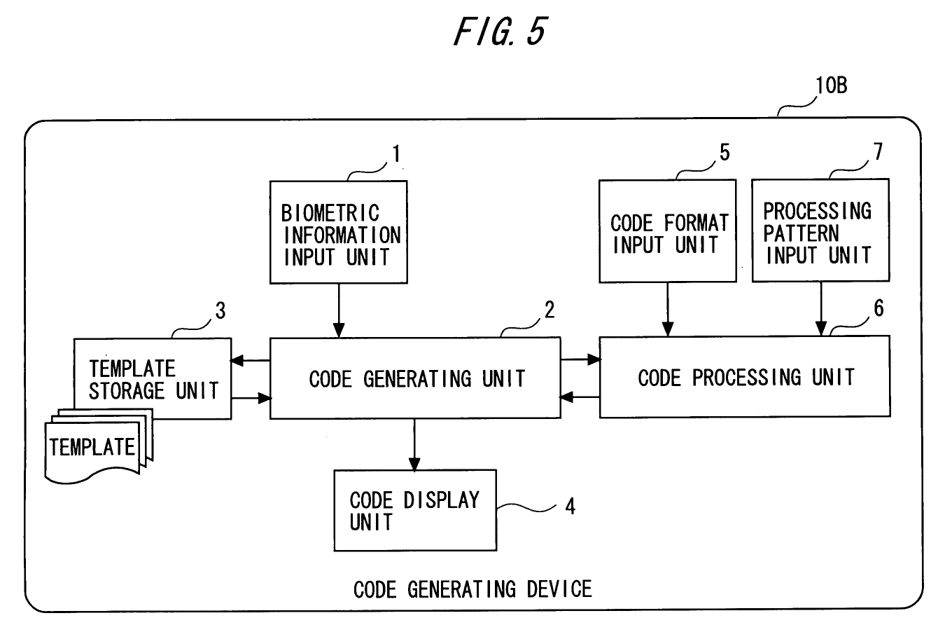

FIG. 5 is a diagram showing an example of a configuration of the third embodiment (the code generating device 10B). The code generating device 10B shown in FIG. 5 has an addition of a processing pattern input unit 7 to the code generating device 10A shown in FIG. 3.

The processing pattern input unit 7 is provided for inputting information used for the user to designate a processing pattern of the code displayed on the code display unit 4. The processing pattern input unit 7 includes, for instance, an input device (e.g., a keyboard, buttons) used for the user to input the processing pattern and a display device on which an input content is displayed. At this time, the processing pattern input unit 7 may also be configured so that options of the processing pattern are displayed on the display device, and the user designates a desired option by the input device (e.g., a pointing device).

The code processing unit 6 processes the code obtained from the template storage unit 3 in accordance with the code format inputted from the code format input unit 5 and the processing pattern inputted from the processing pattern input unit 7. The code processing unit 6 can, however, process the code in accordance with only the processing pattern inputted from the processing pattern input unit 7.

<<Operational Example of Third Embodiment>>

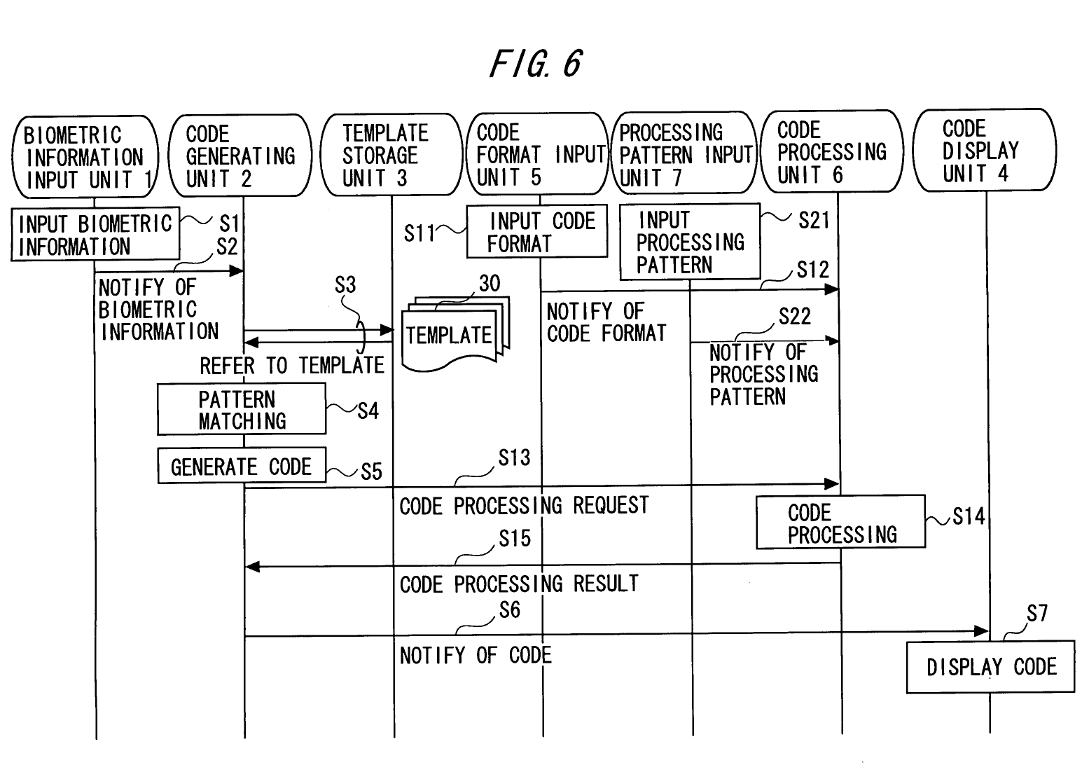

FIG. 6 is a sequence diagram showing an operational example of the code generating device 10B (the third embodiment). The operational example shown in FIG. 6 is in such a state that steps S21 and S22 are added to the operational example shown in FIG. 4. Therefore, the explanation will be focused on steps S21 and S22.

In step S21, the user inputs (designates) the processing pattern of the code by employing the processing pattern input unit 7. The processing pattern input unit 7 notifies the code processing unit 6 of the inputted processing pattern (step S22). The code processing unit 6 retains the processing pattern.

Thereafter, when the code generating unit 2 requests the code processing unit 6 to process the code obtained in step S5 (step S13), the code processing unit 6 processes the code of which the code generating unit 2 notified in accordance with the code format and the processing pattern retained in the code processing unit 6 (step S14).

The code display unit 4 is notified of the processed code (step S6) via the code generating unit 2 (step S15), and the processed code is displayed on the code display unit 4 (step S7). Through this operation, the user can acquire (know) the code corresponding to the code format and the processing pattern designated by the user.

<<Effect of Third Embodiment>>

According to the third embodiment, in addition to the effects explained in the first embodiment and the second embodiment, the following effect can be acquired. To be specific, the code is processed based on the processing pattern, and hence, even if about the same biometric information and in the same code format, the user can obtain the code different for every processing pattern. Accordingly, the code to be outputted can be prevented from being fixed by the biometric information to be inputted with the simple configuration.

### Fourth Embodiment

Next, a fourth embodiment (a code generating device 10C) of the code generating device according to the present invention, will be explained. The fourth embodiment includes common points to the first through third embodiments, and therefore the discussion will be focused on different points.

<<Example of Configuration of Fourth Embodiment>>

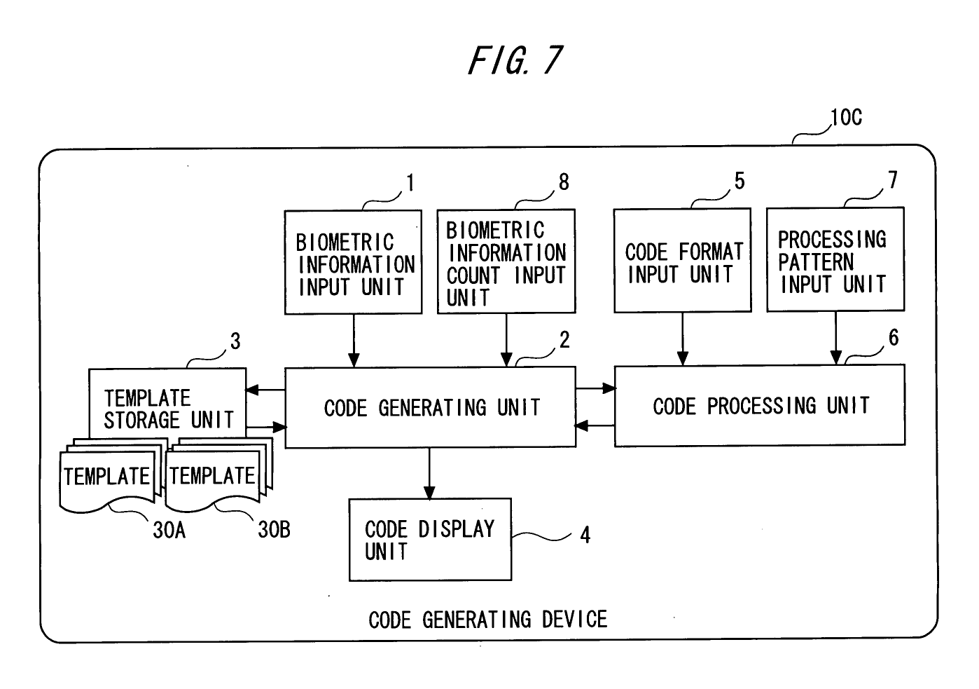

FIG. 7 is a diagram showing an example of a configuration of the fourth embodiment (the code generating device 10C). The code generating device 10C shown in FIG. 7 has an addition of a biometric information count input unit 8 to the code generating device 10B shown in FIG. 5.

In the first through third embodiments, one piece (one category) of biometric information is inputted. By contrast, in the fourth embodiment, a single piece or plural pieces of biometric information is or are inputted from the biometric information input unit 1. If the plural pieces of biometric information are inputted, the code generating device 10C acquires codes matching with the respective pieces of biometric information, then generates a new code by employing these acquired codes, and outputs this new code.

The plural pieces of biometric information may be the same category of biometric information and may also be different categories of biometric information. If the different categories of biometric information are inputted, however, the biometric information input unit 1 is provided with sensors capable of detecting the respective categories of biometric information.

For instance, it can be considered that fingerprints of a plurality of fingers (e.g., the forefinger and the middle finger) are inputted as the same category of biometric information. Further, it can be considered that at least two or more categories of biometric information among the fingerprint, the iris, the retina and the blood vessel are inputted as the different categories of biometric information.

The biometric information count input unit 8 is provided for inputting the number of pieces of biometric information (biometric information count) to be inputted. The biometric information count input unit 8 includes, for instance, an input device (e.g., a keyboard, buttons) used for the user to input the biometric information count and a display device on which an input content is displayed. At this time, the biometric information count input unit 8 may also be configured so that options of the biometric information count are displayed on the display device, and the user designates a desired option by the input device (e.g., a pointing device).

The biometric information count is inputted as information used for the code generating unit 2 to judge whether a new code is to be generated or not. Namely, the code generating unit 2, before the biometric information is inputted, accepts the biometric information count inputted from the biometric information count input unit 8.

At this time, if the biometric information count is 1, the code generating unit 2, at a stage of acquiring the code matching with the first biometric information inputted thereafter, notifies the code display unit 4 of this code.

In this respect, if the biometric information count is equal to or larger than 2, the code generating unit 2 acquires a plurality of codes matching with the two or more pieces of biometric information inputted thereafter, and generates a new code on the basis of these codes. Thereafter, the code generating unit 2 notifies the code display unit 4 of the new code.

Further, in the fourth embodiment, the template storage unit 3 is prepared with a biometric information template group matching with each of plural pieces of biometric information. For example, if two pieces of biometric information (the first biometric information and the second biometric information) at the maximum are inputted, as shown in FIG. 7, the template storage unit 3 is stored with a plurality of biometric information templates 30A (a first biometric information template group) corresponding to the first biometric information and a plurality of biometric information templates 30B (a second biometric information template group) corresponding to the second biometric information.

Note that an input sequence of plural pieces of biometric information is fixed in order to simplify the configuration of the code generating device 10C (e.g., to facilitate the selection of the biometric information template group by the code generating unit 2) in the fourth embodiment. Namely, if only one piece of biometric information is inputted, the user inputs only the biometric information corresponding to the biometric information templates 30A (the first biometric information).

<<Operational Example of Fourth Embodiment>>

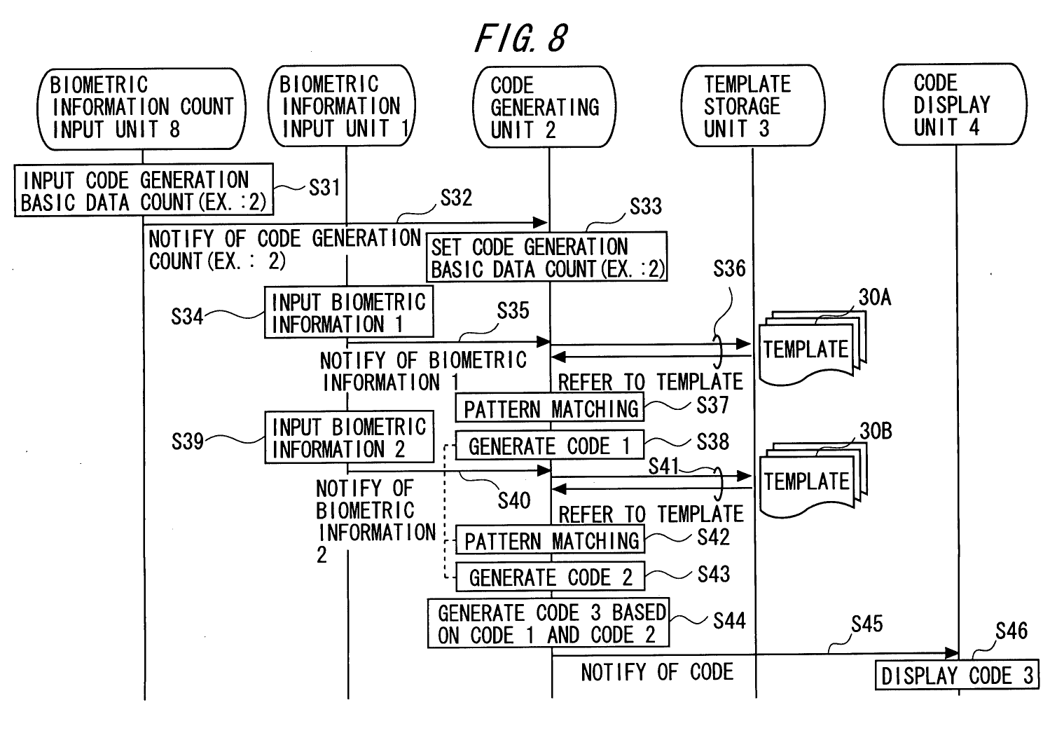

FIG. 8 is a sequence diagram showing an operational example of the code generating device 10C (the fourth embodiment). In the fourth embodiment, the user can input the plural pieces of biometric information in the case of desiring the code based on the biometric information exhibiting high accuracy and the high uniqueness. The sequence shown in FIG. 8 exemplifies an example where the user inputs two categories (two pieces) of biometric information.

In FIG. 8, the user at first inputs the biometric information count (which is herein 2) by use of the biometric information count input unit 8 (step S31). The biometric information count input unit 8 notifies the biometric information count of the code generating unit 2 (step S32). Then, the code generating unit 2 sets (retains) the biometric information count “2” as the number of pieces of biometric information serving as a basis of generating a new code (which is a code generation basic data count). The biometric information count is set in, e.g., a register included in the code generating unit 2.

The user, upon inputting the biometric information count, inputs the biometric information in accordance with the biometric information input sequence.

When the user inputs the first biometric information (biometric information 1) from the biometric information input unit 1 (step S34), the code generating unit 2 is notified of the biometric information 1 (step S35).

The code generating unit 2, when receiving the biometric information 1, refers to the plurality of biometric information templates 30A, which corresponding to the biometric information 1, stored on the template storage unit 3 (step S36), and collates the biometric information with the biometric information samples (e.g., pattern matching) (step S37). Thereby, the code generating unit 2 acquires a code (which is referred to as a code 1) assigned to one of the matching biometric information samples (step S38).

When the user inputs the second biometric information (biometric information 2) subsequently to the biometric information 1 (step S39), the code generating unit 2 is notified of the biometric information (step S40). Then, the code generating unit 2 performs the same operations as those in steps S36-S38 by use of the plurality of biometric information templates 30B corresponding to the biometric information 2. Thereby, the code generating unit 2 acquires a code (code 2) matching with the biometric information 2 (steps S41-S43).

By the way, the code generating unit 2, when setting the basic data count, resets (sets to zero) an unillustrated counter, and increases a counter value by 1 each time the code generating unit 2 receives the biometric information from the biometric information input unit 1. Further, the code generating unit 2, when increases the counter value, compares the counter value with the basic data count.

If the counter value is smaller than the basic data count, the code generating unit 2 judges that there exists the biometric information to be inputted next, and waits for notification of the next biometric information. Whereas if the counter value is equal to or larger than the basic data count, the code generating unit 2 judges that a complete set of codes for generating a new code is prepared. In this case, the code generating unit 2 generates a new code (which is called a code 3) on the basis of the plurality of codes (which are herein the code 1 and the code 2) generated (acquired) so far (step S44).

Thereafter, the code generating unit 2 notifies the code display unit 4 of the code 3 (step S45), and the code 3 is displayed on the code display unit 4 (step S46). This operation enables the user to recognize the code 3 matching with the biometric information 1 and the biometric information 2.

It should be noted that none of the code format input unit 5, the code processing unit 6 and the processing pattern input unit 7 are dealt with in the fourth embodiment discussed so far. Hence, these components can be omitted. An available process may, however, be such that the code format and the processing pattern are inputted through the code format input unit 5 and the processing pattern input unit 7, and the code 3 generated by the code generating unit 2 is received by the code processing unit 6 from the code generating unit 2 and is processed by the code processing unit 6 in accordance with the code format and the processing pattern. In this case, the user is provided with the processed code into which the code 3 is processed.

<<Effect of Fourth Embodiment>>

According to the fourth embodiment, in addition to the effects in the first through third embodiments, the following effect can be acquired. Specifically, according to the fourth embodiment, the new code is generated based on the codes obtained respectively from the plural pieces of biometric information. The new code is higher in its accuracy and uniqueness than the code generated from one piece (one category) of biometric information. This type of code can be provided to the user.

### SPECIFIC EXAMPLE 1

Next, an input/output device and biometric information templates, which can be applied to the first through fourth embodiments (the code generating devices 10, 10A, 10B and 10C) of the code generating devices described above, will be explained by way of a specific example.

FIG. 9 is a diagram showing an external (whole) configuration of the biometric information input unit 1, the code format input unit 5, the processing pattern input unit 6, the biometric information count input unit 8 and the code display unit 4. FIG. 10 is a diagram showing a plurality of biometric information templates stored on the template storage unit 3. The specific example 1 exemplifies an instance where the fingerprint is applied as the biometric information. In the following discussion on the specific example 1, the explanations of the same points as those in the first through fourth embodiments are omitted.

In the example shown in FIG. 9, an area type fingerprint sensor for obtaining a fingerprint image of the user is illustrated as the biometric information input unit 1. A reading method of the fingerprint sensor may take any one of an optical type, a semiconductor type (capacity measuring type) and a heat-sensitive type. Further, a sweep type fingerprint sensor can be applied as the fingerprint sensor.

The user presses a predetermined finger against a sensor surface of the fingerprint sensor of the biometric information input unit 1, whereby the fingerprint sensor reads a fingerprint of this finger. Image information of the read fingerprint is inputted to the code generating unit 2.

Moreover, the example shown in FIG. 9 illustrates an input device 11 employed in common as part of the code format input unit 5, part of the processing pattern input unit 6 and part of the biometric information count input unit 8, a code format display box area 12 functioning as part of the code format input unit 5, a processing pattern display box area 13 functioning as part of the processing pattern input unit 6, and a biometric information input count display box area 14 functioning as part of the biometric information count input unit 8.

The input device 11 has a plurality of keys and a plurality of buttons. The plurality of keys and the plurality of buttons include a key or a button for selecting any one of the display box areas 12, 13 and 14, wherein the user can select the display box area by use of the key or the button.

In a state where the display box area 12 is selected, when operating the input device 11, a numerical value (e.g., the number of digits of the code) representing the code format is displayed in the display box area 12. Thereafter, when a determination key or button included in the input device 11 is pressed, the code processing unit 6 is notified of the numerical value as the code format displayed in the display box area 12.

Further, in a state where the display box area 13 is selected, the user can input a character string (e.g., a processing pattern name) for specifying the processing pattern by employing the input device 11. At this time, the inputted character string is displayed in the display box area 13. Thereafter, when the determination key or button included in the input device 11 is pressed, the code processing unit 6 is notified of the character string, as the processing pattern, displayed in the display box area 13.

Further, in a state where the display box area 14 is selected, the user can input the numerical value representing the biometric information count by operating the input device 11. At this time, the inputted character string is displayed in the display box area 14. Thereafter, when the determination key or button included in the input device 11 is pressed, the code generating unit 2 is notified of the numerical value, as the biometric information count, displayed in the display box area 14.

The code display unit 4 is provided with, as shown in FIG. 9, a display surface (screen) for a character string structuring the code. Note that in the first embodiment, the input device 11 and the display box areas 12, 13 and 14 in the configuration shown in FIG. 9 can be omitted. Further, in the second embodiment, the display box areas 13 and 14 can be omitted. Still further, in the third embodiment, the display box a real 14 can be omitted. Yet further, in the fourth embodiment, the display box areas 12 and 13 can be omitted.

In the specific example 1, the code matching with the biometric information (fingerprint information) is generated by the pattern matching method. Therefore, the template storage unit 3 contains, as shown in FIG. 10, the plurality of biometric information templates (fingerprint template information) 30.

In FIG. 10, each of the biometric information templates 30 contains a fingerprint sample image (fingerprint template: corresponding to a sample) used for the pattern matching and a code that is assigned (imparted) to this sample image and is unique among the sample images. The sample image may be an image obtained from a person serving as a monitor and may also be an artificially created image.

Moreover, as in the fourth embodiment, if the plural types of fingerprints (e.g., a fingerprint of the forefinger and a fingerprint of the middle finger) are inputted, the template storage unit 3 can be previously stored with a biometric information template group corresponding to the fingerprint of each finger.

In the specific example 1, when the user desiring to generate a code from the fingerprint presses the forefinger against the fingerprint sensor of the biometric information input unit 1, the code generating unit 2 is notified of fingerprint information (fingerprint image information).

The code generating unit 2 compares the received fingerprint information with the fingerprint template (the sample image) of the fingerprint template information (the biometric information templates 30) stored on the template storage unit 3, and extracts one fingerprint template exhibiting the highest similarity.

The code generating unit 2 acquires the code assigned to the extracted fingerprint template and notifies the code display unit 4 of this code. The code display unit 4 displays the notified code on the display surface. Through this operation, the user can know the code generated from the user's own fingerprint.

Note that the forefinger is used in the description given above, however, a code different from the above can be also generated in a way that changes the hand or the finger used for the user to input the fingerprint information (it is because a result of the pattern matching changes).

It is to be noted that the specific example 1 has exemplified the instance where the sample image is extracted by the pattern matching method. In such a case that other fingerprint collation method (for example, the minutia method, the minutia relation method, the frequency analyzing method) is applied as a substitute for the pattern matching method, samples corresponding to the collation method to be applied are registered in the biometric information templates 30.

### SPECIFIC EXAMPLE 2

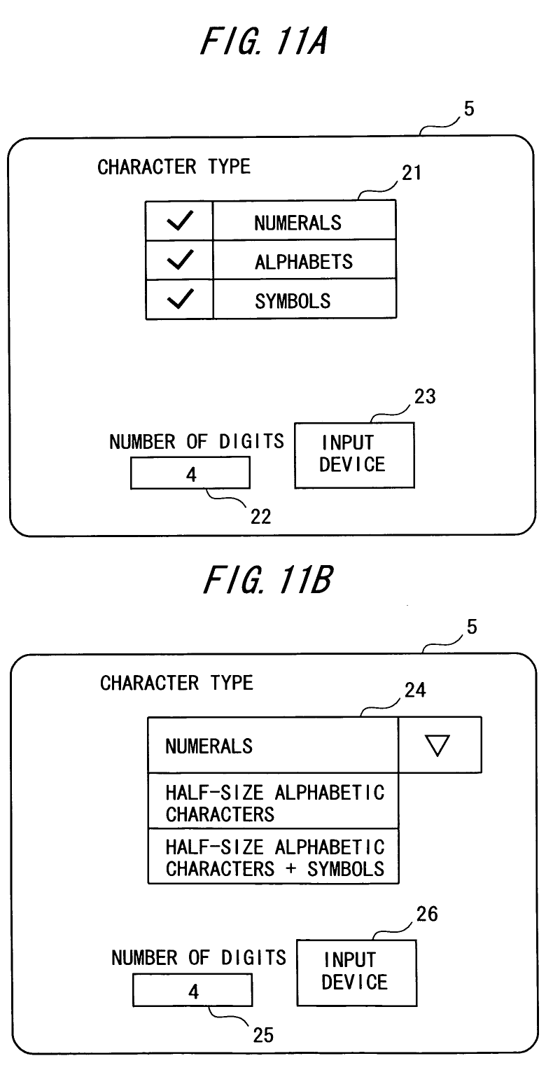

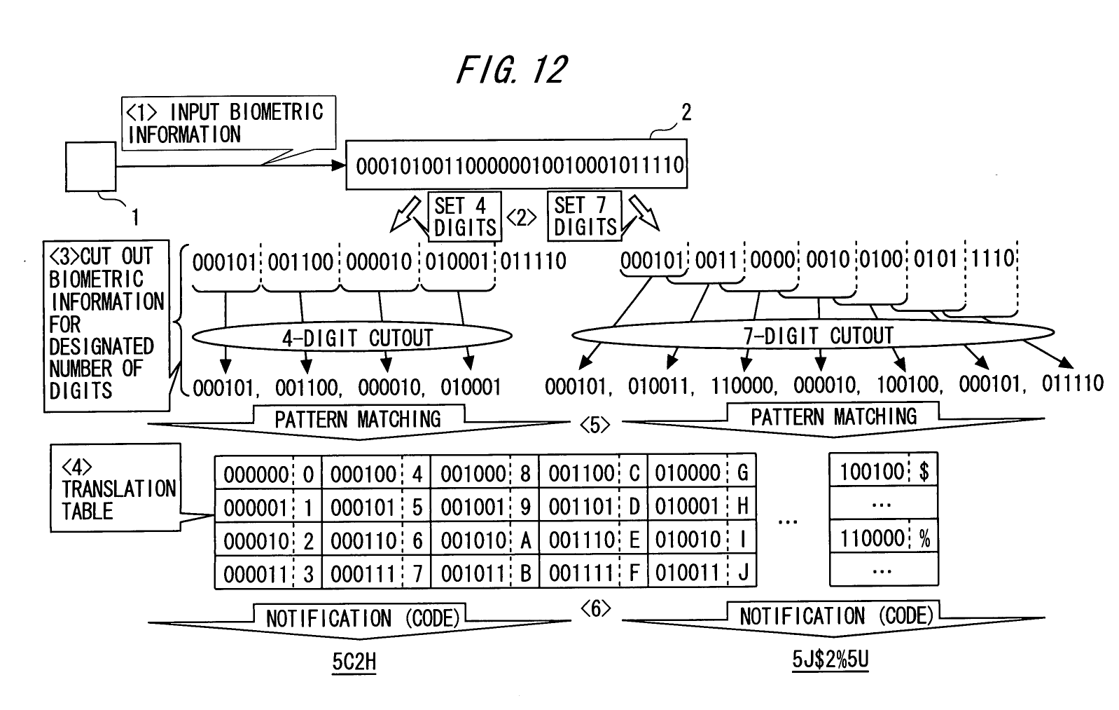

Next, a specific example related to the code format explained in the second embodiment and the third embodiment, will be described by way of a specific example 2. FIGS. 11A and 11B are diagrams showing specific examples of the code format input unit 5. FIG. 12 is a diagram showing a specific example of the code processing based on the code format. In the following discussion on the specific example 2, the explanations of the same points as those in the second embodiment and the third embodiment are omitted.

The user who wants to generate the code previously inputs a desired code format by employing the code format input unit 5. As shown in FIGS. 11A and 11B, as the code format, for instance, a type of the usable characters (numerals, half-size alphabetic characters, symbols, etc.) and the number of digits of the code can be inputted (designated).

The input method may take a formation of making the user directly input values of elements such as the type of the character and the number of digits that build up the code format. Alternatively, the user may be prompted to select one of several code formats preset in the code generating device.

In order for the user to input a more complicated code format, there can be considered a method of preparing the code format input unit 5 with a text input area and prompting the user to input a regular expression (a method of representing a character string pattern such as a character occurrence sequence and a character repeating count). The regular expression is a notation method used for the pattern matching of the character string.

In the specific example shown in FIG. 1A, the code format input unit 5 consists of a character type selection box area 21, a digit count display box area 22 and an input device 23. The input device 23 includes, for example, a key, a button or a pointing device for designating (entering a checkmark in) a desired character type, and a ten-key for inputting the number of digits. The user can select one of the character types from the numerals, alphabets, the symbols and an arbitrary combination thereof by operating the input device 23. Moreover, an arbitrary number can be inputted as the number of digits. Notification of the character type and the number of digits, which are designated and inputted by the input device 23, is given as the code format to the code processing unit 6.

In the specific example shown in FIG. 11B, the code format input unit 5 consists of a character type selection box area 24, a digit count display box area 25 and an input device 26. The input device 26 includes, for example, a key, a button or a pointing device for designating a desired character type menu by opening pull-down menu in the selection box area 24, and a ten-key for inputting the number of digits. The user can select the character type from any one type of elements among the numerals, half-size characters, half-size characters plus symbols by operating the input device 26. Further, an arbitrary number can be inputted as the number of digits. Notification of the character type and the number of digits, which are designated and inputted by the input device 26, is given as the code format to the code processing unit 6.

Next, a processing example in the case of processing a 30-digit code “000101001100000010010001011110” obtained from the biometric information into codes based on a “4-digit” code format and a “7-digit” code format, will be explained with reference to FIG. 12 by way of a specific example of the code processing of the code processing unit 6 based on the code formats.

In FIG. 12, when the biometric information is inputted from the biometric information input unit 1 (<1> in FIG. 12), the code generating unit 2 acquires the code (30 digits) matching with the biometric information by use of the methods explained in the second embodiment and the third embodiment. The code generating unit 2 notifies the code processing unit 6 of the acquired code <2> in FIG. 12).

The code processing unit 6 extracts, based on the number of digits designated as the code format, code segments (partial aggregation) according to the number of digits out of the 30-digit code (<3> in FIG. 12). Herein, if the processed code format is 4 digits, the code processing unit 6 cuts out (extracts), for instance, four data segments by 6 digits from the head (the left side on the sheet surface is set as the head).

Along with this, if the processed code format is 7 digits, the code processing unit 6 extracts, for example, the first data from the first digit, the second data from the fifth digit, the third data from the ninth digit and so on, thus respectively extracting the data by every 6 digits. The number of digits extracted from the original code data and an extraction start position can be, however, arbitrarily set irrespective of the number of digits of the processed code.

Next, the code processing unit 6 translates each of the extracted code segments into a corresponding value by use of a translation table (<4> in FIG. 12: which is prepared beforehand in the code processing unit 6) for processing the data (<5> in FIG. 12). Namely, the code processing unit 6 extracts the corresponding value by the pattern matching between the segment (segmental data) consisting of 6-digit numerals and the translation table. Herein, the segmental data is each translated into a 1-digit character.

The number of digits of the segment (code segment) and the post-translation value (the number of digits after translation) can be, however, properly changed. Further, if the original code (segments) consist of alphabets, the translation table can be specified so that the post-translation value also consists of the alphabets. Moreover, FIG. 12 illustrates the translation table in which the original code (segments) is translated into any one type of elements among the numerals, the alphabets and the symbols. By contrast, the translation table prepared for every character type can be also structured so as to be used corresponding to the designated character type.

Then, the code processing unit 6 generates the processed code by combining the characters into which the respective segments are translated, and notifies the code generating unit 2 of the processed code (<6> in FIG. 12). Through this type of code processing, the 30-digit code described above is segmented into a processed code of a 4-digit character string “5C2H” and a processed code of a 7-digit character string “5J$2%5U”. The user is notified of the processed code via the code display unit 4.

The user can be provided with the plurality of processed codes as shown in FIG. 12 by inputting the plurality of code formats. In this case, the user can select one favorite code from within the plurality of processed codes provided.

### SPECIFIC EXAMPLE 3

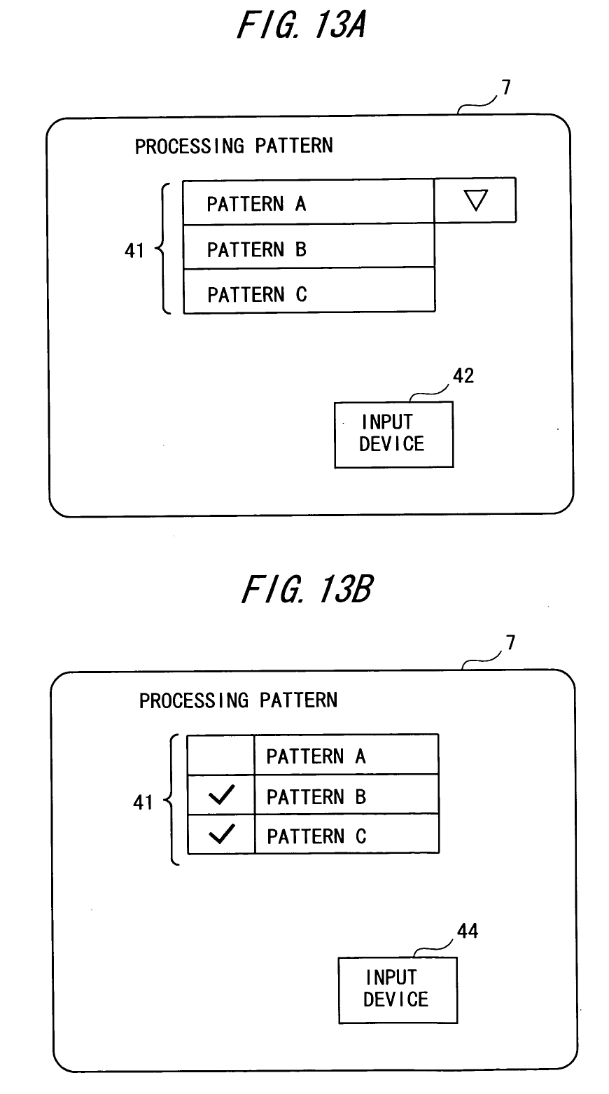

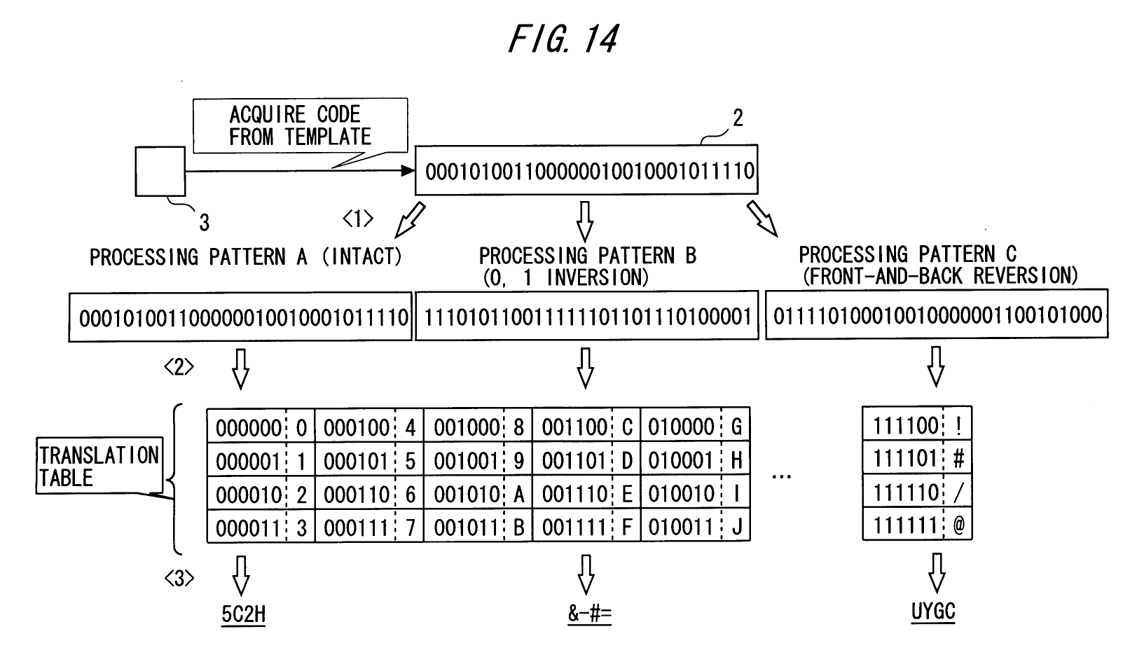

Next, a specific example explained in the second embodiment will be described by way of a specific example 3. FIGS. 13A and 13B are diagrams showing specific examples of the processing pattern input unit 7. FIG. 14 is a diagram showing a specific example of the code processing based on the processing pattern and the code format. In the following discussion on the specific example 3, the explanations of the same points as those in the third embodiment are omitted.

The user who wants to generate the code previously inputs a code format and a processing pattern of the code by employing the code format input unit 5 and the processing pattern input unit 7.

Applicable methods are a method (method 1) of having one processing pattern chosen from within several processing patterns preset in the device and a method (method 2) of combining the plurality of designated processing patterns.

An example shown in FIG. 13A corresponds to the method 1. In this example, the processing pattern input unit 7 has a selection box area 41 for displaying a plurality of processing patterns (e.g., patterns A, B and C) as options in a pull-down menu, and an input device 42 for designating and inputting any one of the processing patterns displayed in the selection box area 41. The user can designate and input one of the processing patterns by operating the input device 42.

An example shown in FIG. 13B corresponds to the method 2. In this example, the processing pattern input unit 7 has a selection list 43 of the plurality of processing patterns each having a check box, and an input device 44 used for the user to enter a check mark of the desired processing pattern. The user can designate and input one or more processing patterns by entering the checkmark (s) in the checkbox(es) in a way that operates the input device 44.

Next, an operational example in the case of processing a 30-digit code “000101001100000010010001011110” obtained from the biometric information into “4-digit” codes, will be explained with reference to FIG. 14 by way of an example of the code processing of the code processing unit 6 based on the processing pattern and the code format.

In FIG. 14, the original code (e.g., 30-digits) acquired from the template storage unit 3 is transferred together with a processing request from the code generating unit 2 to the code processing unit 6. The code processing unit 6, upon receiving the original code, refers to the processing patterns inputted from the processing pattern input unit 7 and executes the processing based on this pattern.

At first, a new 30-digit code based on the processing pattern is generated from the original 30-digit code (<1> in FIG. 14). Herein, a processing pattern A (no change), a processing pattern B (0-and-1 inversion) and a processing pattern C (front-and-back reversion) are given by way of an example of the processing patterns.

Hereafter, the processed 30-digit codes are translated into 4-digit characters by the same method (FIG. 12) as the processing method explained in the specific example 2 (<2> in FIG. 14). With this processing, the different processed codes for every processing pattern can be generated (<3> in FIG. 14). In the example in FIG. 14, a processed code using the processing pattern A becomes “5C2H”, a processed code using the processing pattern B becomes “&-#=”, and a processed code using the processing pattern C becomes “UYGC”. The user is notified of these processed codes via the code display unit 4.

Note that in the example shown in FIG. 14, the processing patterns are applied to the original 30-digit code. As a substitute for this, it is possible to apply a method by which, for instance, translation tables each different for every processing pattern are created and separately used according to the inputted processing pattern.

Further, a method can be considered, wherein the processed codes processed based on the code formats as explained in the specific example 2 are processed according to the processing patterns. Moreover, it is also possible to consider that using one processing pattern obtained by combining contents of several processing patterns as mentioned above.

According to the specific example 3, the method described above, even in the case of the same biometric information and the same code format, enables the user to be provided with the plurality of processed codes generated based on the processing patterns from one category of biometric information by designating the processing patterns. The user can select the desired code from the plurality of processed codes of which the notification is given via the code display unit 4.

### SPECIFIC EXAMPLE 4

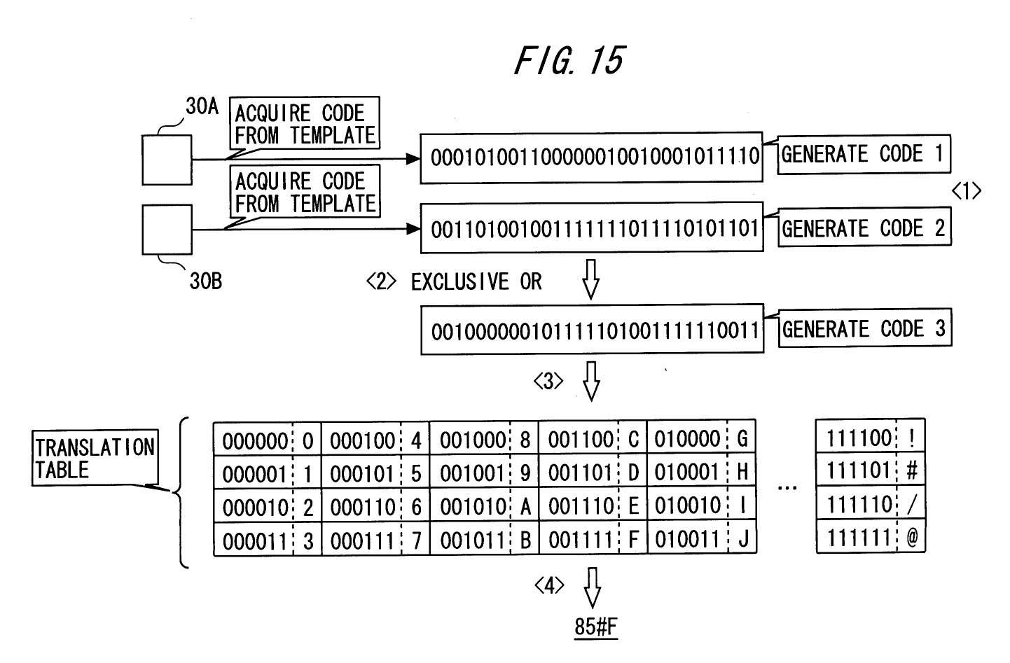

Next, a specific example of the fourth embodiment will be explained by way of a specific example 4. FIG. 15 is a diagram showing an example of the code generation by inputting plural pieces (categories) of biometric information. As described above, the methods that can be considered as the methods of generating the codes from the plural pieces (categories) of biometric information are a method (i) of generating the codes from a plurality of different categories, such as the fingerprint, the iris and the veins, of biometric information, and a method (ii) of generating the codes from plural pieces of biometric information in the same category (e.g., the respective fingerprints of the forefinger and the middle finger).

The example of generating the codes by inputting two items of biometric information such as “the fingerprints of the middle finger and the forefinger” defined as the same category of biometric information, will hereinafter be described with reference to FIG. 15. In the following discussion on the specific example 4, the explanations of the same points as those in the fourth embodiment are omitted.

The user, on the occasion of starting the code generation, inputs the biometric information count to the biometric information count input unit 8 (FIG. 7). Herein, “2” is inputted as the biometric information count. Thereafter, the user sequentially inputs the fingerprint of the forefinger and the fingerprint of the middle finger by employing the biometric information input unit 1 including the fingerprint sensor as explained in the specific example 1 (FIG. 9).

Thereupon, in the code generating device 10C, processes (FIG. 8) in steps S34-S43 are executed. With these processes executed, a code 1 corresponding to the middle finger and a code 2 corresponding to the forefinger are generated in the code generating unit 2 (<1> in FIG. 15).

Next, the code generating unit 2 executes the following process in step S44 (FIG. 8). To be specific, as shown in FIG. 15, for example, a new code 3 is generated by taking an exclusive OR of the code 1 and the code 2 (<2> in FIG. 15).

In the specific example 4, the code generating unit 2 notifies the code processing unit 6 of the code 3. Then, for instance, the user is notified of the code 3 as a processed code (<4> in FIG. 15) via logic (the processing based on the code format) exemplified in the specific example 2 and/or logic (the processing based on the code format and the processing pattern) exemplified in the specific example 3 (<3> in FIG. 15).

It is to be noted that the specific example 4 involves using the fingerprints of the middle finger and the forefinger for generating the codes, however, it is possible to employ other pieces of biometric information (regardless of whether the category is different or the same) different from those pieces of biometric information. Further, the specific example 4 employs the exclusive OR for generating the new code from the plurality of codes. A method of generating a new code from a plurality of codes, which is different from the aforementioned method, can be, however, applied, (for example, AND and OR are taken, and part of the code 1 and the part of the code 2 are extracted and joined).

<Effect of Embodiment>

The embodiments discussed above have the following advantages in addition to the effects described above.

Namely, the user has no necessity of memorizing or recording the authentication code and is released from troublesomeness of reissuing the authentication code due to forgetting the code and losing the record.

Further, the code generating device in the embodiment can be provided as the function independent of the backbone system (the authentication system). Therefore, it is feasible to restrain development/introduction costs at a low level. Moreover, the necessity of managing the user's biometric information is eliminated, and it is therefore possible to restrain the management cost and to obviate anxiety about leakage of the biometric information.

Further, in the case of a method of authenticating by collating with the user's biometric information previously recorded in the user-side device, all the users are required to hold the devices, however, the present device can be shared. Hence, all the users have no necessity of holding the devices, and the introduction cost can be restrained.

### MODIFIED EXAMPLE

The code generating device in the embodiment may have a network interface, and this network interface may function as one of the biometric information units receiving the user's biometric information via a network.

Part or the whole of the network in this case may be a wireless region. For instance, an available configuration is that the biometric information (e.g., the fingerprint information) inputted to a mobile phone (cellular phone) is inputted via the network.

Further, an available configuration is that the network interface is provided in the code generating device and functions as one of the output units, and the generated code is transmitted to a predetermine address via the network.

Moreover, in the embodiment discussed above, the code display unit 5 serving as the output unit of the code generating device displays the character string structuring the code. In place of this, the code generating device can be constructed to inform of (output) the code in voice uttered from a loudspeaker. In the case of informing of (outputting) the code in voice, a preferable configuration is that only the user can hear the voice through, for example, headphones and earphones.

[Others]

The disclosure of Japanese Patent Application No. JP2005-196532 filed on Jul. 5, 2005 including the specification, drawings and abstract is incorporated herein by reference in its entirety.

What is claimed is:

1. A code generating device using biometric information, comprising:
an input unit of biometric information;
a storage unit stored with a plurality of biometric information patterns and with codes each uniquely assigned to each biometric information pattern;
a code generating unit extracting one of the plurality of biometric information patterns, which corresponds to the inputted biometric information, and acquiring the code assigned to the extracted biometric information pattern; and
an output unit outputting the code acquired by the code generating unit.

2. A code generating device using biometric information according to claim 1, further comprising:
an input unit of a code format; and
a code processing unit processing the code acquired by the code generating unit in accordance with the inputted code format,
wherein the output unit outputs the processed code.

3. A code generating device using biometric information according to claim 1, further comprising:
an input unit of a code pattern of the code; and
a code processing unit processing the code acquired by the code generating unit in accordance with the inputted processing pattern, wherein the output unit outputs the processed code.

4. A code generating device using biometric information according to claim 2, further comprising:
an input unit of a processing pattern of the code, wherein the code processing unit processes the code acquired by the code generating unit in accordance with the inputted code format and the inputted processing pattern, and the output unit outputs the processed code.

5. A code generating device using biometric information according to claim 1, wherein the code generating unit, when plural pieces of biometric information are inputted from the biometric information input unit, extracts the biometric information patterns corresponding to respective pieces of biometric information, acquires a plurality of codes corresponding to the respective biometric information patterns extracted, and generates a new code from the plurality of codes.

6. A code generating method using biometric information in a code generating device including an input unit, a storage unit stored with a plurality of biometric information patterns and with codes each uniquely assigned to each biometric information pattern, a code generating unit, and an output unit, the method comprising:
the code generating unit extracting one of the plurality of biometric information patterns, which corresponding to the biometric information inputted from the input unit, by referring to the storage unit, and acquiring the code assigned to the extracted biometric information pattern; and
the output unit outputting the acquired code.

7. A code generating method using biometric information according to claim 6, further comprising:
a code processing unit included in the code generating device processing the acquired code in accordance with a code format inputted from the input unit; and
the output unit outputting the processed code.

8. A code generating method using biometric information according to claim 6, further comprising:
a code processing unit included in the code generating device processing the acquired code in accordance with a processing pattern inputted from the input unit; and
the output unit outputting the processed code.

9. A code generating method using biometric information according to claim 7, further comprising:
a code processing unit included in the code generating device processing the acquired code in accordance with a code format and a processing pattern inputted from the input unit; and
the output unit outputting the processed code.

10. A code generating method using biometric information according to claim 6, wherein the code generating unit, when plural pieces of biometric information are inputted from input unit, extracts the biometric information patterns corresponding to respective pieces of biometric information by referring to the storage unit, acquires a plurality of codes corresponding to the respective biometric information patterns extracted, and generates a new code from the plurality of codes.
